(19) United States
(12) Patent Application Publication
(10) Pub. No.: US 2002/0037237 A1
(43) Pub. Date: Mar. 28, 2002

(54) Automated precision object holder and method of using same

(76) Inventors: James K. Mainquist, San Diego, CA (US); Robert C. Downs, San Diego, CA (US); Mark R. Weselak, San Diego, CA (US); Andrew J. Meyer, San Diego, CA (US)

Correspondence Address: GENOMICS INSTITUTE, OF THE NOVARTIS RESEARCH FOUNDATION, 3115 MERRYFIELD ROW, SUITE 200, SAN DIEGO, CA, 92121, US

(21) Appl. No.: 09/929,985

(22) Filed: Aug. 14, 2001

Related U.S. Application Data
(63) Continuation-in-part of application No. PCT/US01/19274, filed on Jun. 15, 2001.
Application No. PCT/US01/19274 is a continuation-in-part of application No. 09/596,752, filed on Jun. 15, 2000, now abandoned.

(51) Int. Cl. G01N 35/00

(52) U.S. Cl. 422/63; 422/104

(57) ABSTRACT

This invention provides an object holder for precisely positioning an object such as a microtiter plate on a support fixture. The object holders can also include a retaining device on a support fixture for receiving an object. In use, the object is generally positioned on the fixture relative to alignment surfaces of the object. Pushers then precisely position the object in a desired location. The invention also provides integrated systems that coordinate the actions of different components of the object holders. For example, once an object is in a desired position, a controller can activate a retaining device to retain the object in the object holder in the desired orientation.

### CROSS-REFERENCE TO RELATED APPLICATIONS

This application is a continuation-in-part of International Application No. PCT/US01/19274, filed Jun. 15, 2001, which is a continuation-in-part of U.S. application Ser. No. 09/596,752, filed Jun. 15, 2000, which applications are incorporated herein by reference for all purposes.

### BACKGROUND OF THE INVENTION

1. Field of the Invention

This invention pertains to the field of automated mechanical systems. More specifically, the present invention relates to an automated system for precisely positioning an object for further automated processing.

2. Background

Many industrial fields require the precise positioning of an object for automated processing. The success of the human genome project, for example, is due in part to a transition from traditional laboratory bench top processes to more automated high-throughput systems. The studies in genomics and proteomics that are required to interpret the data obtained from the human genome project will likewise require improved high-throughput systems. High-throughput systems are also used for synthesis of large numbers of compounds and the subsequent screening of such libraries of compounds.

To increase throughput, these automated systems for chemical synthesis and for screens and assays typically employ a microtiter (or specimen) plate. The microtiter plates can be used, for example, to hold multiple compounds and materials, to conduct multiple assays on one or more compounds, to facilitate high throughput screening and to accelerate the production and testing of a large number of samples. Each microtiter plate typically has many individual sample wells, for example hundreds or even more than a thousand wells. Each of the wells forms a container into which a sample or reagent is placed. Since an assay or synthesis can be conducted in each sample well, hundreds or thousands of tests can be performed using a single plate. Microtiter plates are configured to meet industry standards. For example, some commonly used standard plates have 96, 384, or 1,536 wells. Such plates are available from, for example, Greiner America Corp., P.O. Box 953279, Lake Mary, Fla. 32795-3279. The plates generally can be heated, cooled, or shaken to facilitate a desired process.

Coupling the use of microtiter plates with automated processing systems enable the synthesis and/or testing of hundreds of thousands of samples in a single day. Automated equipment, such as automated liquid dispensers, can receive appropriately configured microtiter plates and deposit samples or reagents into the plate wells. Other known automated equipment facilitates the processing and testing of samples using loaded microtiter plates.

In order to perform a high throughput assay with a high degree of reliability and repeatability, the high throughput system needs to accurately, quickly, and reliably position individual microtiter plates for processing. For example, microtiter plates must be placed precisely under liquid dispensers to enable the liquid dispenser to deposit samples or reagents into the correct sample wells. A positioning error of only a few thousandths of an inch can result in a sample or reagent being dispensed into a wrong sample well. Such a mistake can not only lead to a failed test, but such a mistake can lead to incorrect test results which others may rely upon for critical decision making, such as a medical treatment path for a patient. Further, even a minor positioning error may cause a needle or tip of the liquid dispenser to crash into a wall or other surface, thereby damaging the liquid dispenser.

Current, conventional automated positioning devices are not known to operate with sufficient positioning accuracy to reliably and repeatably position a high-density microtiter plate for automated processing. For example, typical conventional robotic systems generally achieve a positioning tolerance of about 1 mm. Although such a tolerance is adequate for some low density microtiter plates, such a tolerance is unacceptable for high density plates, such as a plate with 1536 wells. Indeed, a positioning error of one mm for a 1536 well microtiter plate could cause a sample or reagent to be deposited entirely in the wrong well, or cause damage to the system, such as to needles or tips of the liquid dispenser.

Due to the imprecision in placement of microtiter plates using conventional known systems, additional precautions are generally taken to avoid undesirable test results. For example, tests or screens may be conducted using manual intervention to assure plates are properly positioned prior to performing a high precision task, such as dispensing sample or reagent into sample wells. Such manual intervention, however, dramatically slows the automated process and is not highly repeatable due to the normal inaccuracies and uncertainties relating to human handling.

Alternatively, tests or screens may be performed using lower density microtiter plates with fewer sample wells. In that regard, the physical size of the well is larger so the conventional automated system is more likely to process the correct well. For example, a test can be performed using a plate with only 96 wells, rather than a more dense 1536 wells. By having fewer sample wells the need for accuracy is decreased, and the repeatability and reliability of the test may be improved. However, by using microtiter plates with fewer sample wells, the overall throughput from an automated system dramatically falls. The cost of each assay is increased dramatically, as the larger wells of the lower-density plates require larger volumes of reagents. Such an inefficient use of system resources is not only costly from a financial standpoint, but may result in the delayed discovery of important biotechnology or medical therapies.

In another effort to assure reliability in conventional systems, several sample wells in a microtiter plate may be identified as control wells. These control wells are strategically positioned such that if a step of the automated process is completed while the plate is mispositioned, the control well receives a particular known sample or reagent. At a later time in the process, the control wells are tested to determine if the particular known sample or reagent was introduced into the control well. If so, the microtiter plate will be identified as having been mishandled and may be appropriately disregarded. For example, a microtiter plate having a control well that fails quality assurance will be removed from the high throughput screening system and all test results from that microtiter plate ignored. Although such a system offers some assurance of the reliability of a test, throughput for the entire system is reduced by the number of cells required as control cells. Further, the system does not recognize positioning errors until later in the processing cycle, which wastes valuable system resource for continued processing of a mishandled plate.

Robotics and automated processing systems are also used in other industries. Often, such systems require that an object be precisely positioned and retained in that position. For example, a robotic system for machining a part to close tolerances requires that the part be held in a precise location relative to the machining devices.

Therefore, a need exists for an object holder that can accurately, reliably, and quickly position an object for further processing in an automated system. The present invention fulfills these and other needs.

### SUMMARY OF THE INVENTION

The present invention provides positioning devices for precisely positioning a microtiter plate on a support. The positioning devices have at least a first alignment member that is positioned to contact an inner wall of the microtiter plate when the microtiter plate is in a desired position on the support. An inner wall 88 of a microtiter plate is shown in, for example, FIG. 4. In some embodiments, two or more alignment members are positioned to contact a single inner wall of the microtiter plate when the microtiter plate is in the desired position on the support. The use of an inner wall of the microtiter plate as an alignment surface greatly increases the precision with which the microtiter plate is positioned on the support compared to, for example, aligning the microtiter plate using an outer wall, thereby facilitating further processing of the samples contained in the microtiter plate. The positioning devices can further include at least a second alignment member that is positioned to contact a second wall of the microtiter plate when the microtiter plate is in the desired position on the support. This second wall is preferably an inner wall of the microtiter plate.

The invention also provides a retaining device for retaining a microtiter plate in a desired position on a support. The retaining devices include a vacuum plate which, when a vacuum is applied, holds the microtiter plate in the desired position. The vacuum plate, in some embodiments, has an interior surface and a lip surface, with the interior surface being recessed relative to the lip surface.

Also provided by the invention is an object holder for precisely positioning an object on a support. The object holders include: a) a first pusher for moving the object in a first direction so that a first alignment surface of the object contacts a first set of one or more alignment members; and b) a second pusher for moving the object in a second direction so that a second alignment surface of the object contacts a second set of one or more alignment members. In presently preferred embodiments, either or both of the pushers includes a lever pivoting about a pivot point. The lever can be operably attached to a spring or equivalent, which causes the pusher to apply a constant force to the object to, for example, move the object in the first direction against the first set of alignment members.

The object holders of the invention can also include a controller that first directs the first pusher to move the object in a first direction, then directs the second pusher to move the object in a second direction, and (optionally) subsequently directs a retaining device to be activated.

Also provided by the invention are automated processing systems that include one or more of the object holders, positioning devices, and retaining devices described herein. These automated processing systems are useful, for example, for performing high-throughput assays or reactions in microtiter plates, among other things. The automated processing systems can include a robotic device for placing a microtiter plate on the object holders. Liquid dispensers that can deposit reagents in wells of the microtiter plates also are often included in the automated processing systems.

The invention also provides object holders that are constructed to precisely retain an object in a desired orientation. To facilitate precise and efficient positioning, the object holder has a retaining device on a support fixture for receiving the object. First and second alignment members are supported on the fixture for cooperating with respective alignment surfaces on the object. The object is generally positioned relative the alignment members. A first pusher is arranged to move one alignment surface of the object against the first alignment member, and a second pusher is arranged to move the other alignment surface of the object against the second alignment member, thereby moving the object precisely into a desired orientation. With the object precisely in the desired orientation, a controller activates the retaining device to retain the object in the object holder in the desired orientation. In use, the object is generally positioned on the fixture relative to the alignment surfaces. The first pusher and the second pusher move the object into the desired orientation, and the retaining device is activated.

The object holders are, in some embodiments, adapted to position and retain microtiter plates. Both the first and second alignment surfaces are generally wall surfaces of the plate. Microtiter plates are generally substantially rectangular, with an x-axis and a y-axis (FIGS. 3-5). Thus, the first alignment surface can be a y-axis wall, and the first pusher cooperates with another y-axis wall. The second alignment surface can then be an x-axis wall, and the second pusher cooperates with another x-axis wall. Microtiter plates also generally have an inner wall 88 and an outer wall 85, the outer wall generally defining the peripheral shape of the plate, and the inner wall generally defining a well area 92 on the plate. In presently preferred embodiments, both the first and second alignment members are received in an area 94 between the outer wall and an inner wall. The object holders can include retention device that includes a vacuum plate that cooperates with a bottom of the well area 92 to securely hold the plate.

Advantageously, the object may be generally positioned relative the alignment surfaces using a positioning device having a relatively large positioning tolerance. For example, the object may be positioned using a robotic device with about one mm tolerance, and then the object holder can more precisely orient the object. Accordingly, the object holder may be used in conjunction with known, conventional positioning devices to more precisely position objects.

Also provided by the invention are methods of receiving and retaining an object in a desired orientation. The objects have a first alignment surface and a second alignment surface, and the methods involve: a) placing the first alignment surface of the object loosely adjacent a first alignment member, and placing the second alignment surface of the object loosely adjacent a second alignment member; b) moving a first pusher against the object so that the first alignment surface is held firmly against the first alignment member; c) moving a second pusher against the object so that the second alignment surface is held firmly against the second alignment member; and d) clamping, responsive to verifying the first and second pusher are properly tensioned, the object securely to a fixture.

Software programs for directing a computer to carry out these and related methods for precisely positioning objects are also provided. For example, the invention provides a software program that operates on a controller to implement a method that has the following steps: a) receiving a signal that a microtiter plate has been generally positioned on a vacuum plate; b) activating a first pusher to move the microtiter plate into contact with a first alignment member; and c) activating a second pusher to move the microtiter plate into contact with a second alignment member. The steps involved in positioning the object can involve, for example, a) generating a y-axis signal; b) transmitting the y-axis signal to a y-axis piston to cause the y-axis piston to move a y-axis pusher lever into contact with the object to move the object against a y-axis alignment member; c) receiving a signal that the y-axis pusher lever is properly positioned; d) generating an x-axis signal; e) transmitting the x-axis signal to an x-axis piston to cause the x-axis piston to move an x-axis pusher into contact with the object to move the object against an x-axis alignment member; f) receiving a signal that the x-axis pusher is properly positioned; g) generating a vacuum signal to activate a vacuum source that clamps the object firmly against the vacuum plate; h) generating a ready signal that indicates the object is precisely positioned; and i) transmitting the ready signal to another processing device.

### BRIEF DESCRIPTION OF THE DRAWINGS

FIG. 1 is a perspective view of an object holder made in accordance with the present invention.

FIG. 2 is a top view of an object holder made in accordance with the present invention.

FIG. 3 is a top view of a microtiter plate.

FIG. 4 is a bottom view of the microtiter plate shown in FIG. 3.

FIG. 5 is a cross-sectional view of the microtiter plate shown in FIG. 3.

FIG. 6 is a diagrammatic representation of an x-axis pusher and a y-axis pusher positioning a microtiter plate.

FIG. 7 is a block diagram showing electrical, vacuum, and air interconnections in an object holder made in accordance with the present invention.

FIG. 8 is a partial cross-sectional view of a y axis pusher lever made in accordance with the present invention.

FIG. 9 is a partial exploded view of the piston and lever mechanism for a y axis pusher made in accordance with the present invention.

FIG. 10 is prospective view of a y axis pusher lever made in accordance with the present invention.

FIG. 11 is a diagram showing part placement on the underside of an object holder made in accordance with the present invention.

FIG. 12 is a flowchart showing a method of precisely positioning an object according to the present invention.

FIG. 13 is a method of removing a plate from an object holder in accordance with the present invention.

### DETAILED DESCRIPTION

The invention provides devices for precisely positioning objects on a support, and for retaining objects in a desired position on a support. The devices are often used in conjunction with automated systems, such as robotic systems, that require precise placement of an object that is to be subjected to further processing. For example, robotic systems used in biotechnology often use microtiter plates as containers for samples and reagents. The microtiter plates must be precisely positioned on the appropriate support in order for the other components of the system to properly interact with the samples contained in the microtiter plate wells. Similarly, a device of the invention is useful for positioning block material for highly precise milling work.

Positioning Devices

The invention provides positioning devices for precisely positioning an object on a support. Once an object is generally positioned near a desired position, the positioning devices move the object to the precise desired position. Accordingly, the object holders of the invention can be used in conjunction with known, conventional positioning devices to more precisely position objects. For example, conventional automated devices, such as known robotic positioning devices, can place an object on a support. Such previously known robotic devices are generally capable of moving and positioning an object such as a microtiter plate within about a one mm tolerance. In that regard, the known robotic systems can generally position the microtiter plate on a support, but are not capable of achieving the precision required for positioning high density microtiter plates. A positioning error of one mm for a high-density (e.g., 1536 well or greater) microtiter plate could cause a sample or reagent to be deposited entirely in the wrong well, or cause damage to the system, such as to needles or tips of the liquid dispenser.

The object holders of the invention generally include one or more alignment members against which a surface of an object is in contact when the object is in a desired position on the object holder. The alignment members are arranged such that when an object such as a microtiter plate is initially positioned near the alignment members, the object is generally positioned for further processing. Such general positioning may be accomplished with conventional, known robotic systems. For example, the general positioning may place the object within one mm of its desired orientation. However, such a general positioning of the microtiter plate or other object is insufficiently precise for high throughput processing. After the object is generally positioned, the object holder of the invention is activated to more precisely position the object for further processing.

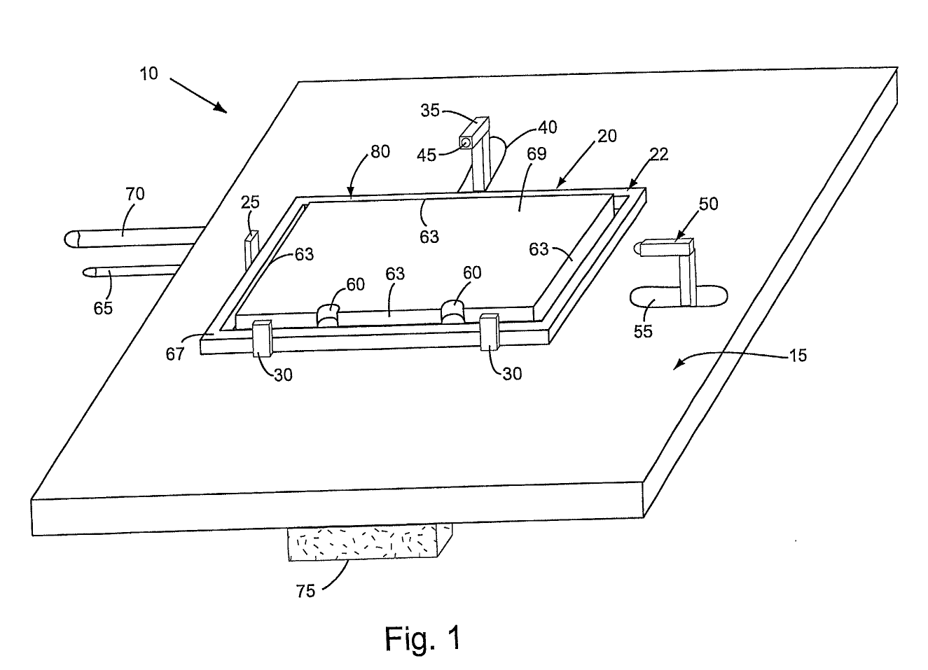

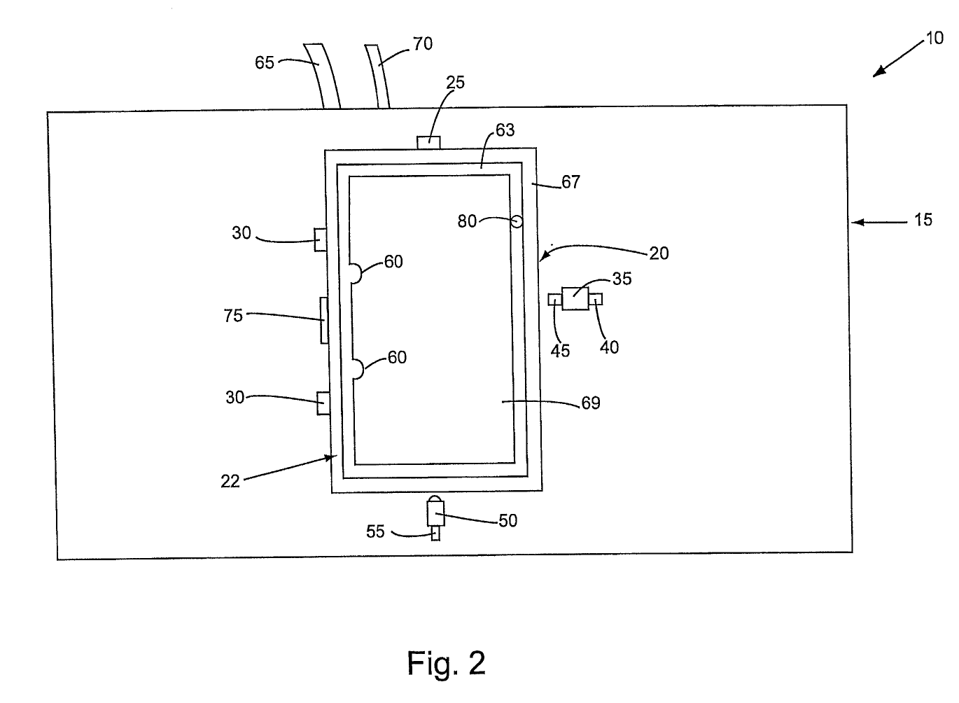

For precise positioning along two different axes, the object holders of the invention generally have one or more alignment members along each of the two axes of the object. For example, FIGS. 1 and 2 show one embodiment of an automated object holder 10 in accordance with the present invention. Object holder 10 generally comprises a fixture 15 supporting a retaining device 20. The protrusions 25 and 30 function as alignment members. The illustrated embodiment of the object holder 10 has two y-axis protrusions 30 and an x-axis protrusion 25 supported from the fixture 15. Accordingly, the y-axis protrusions 30 and x-axis protrusion 25 are fixedly positioned relative to the vacuum plate 20, which, in this embodiment, acts to hold the object in position once it has been precisely positioned. The y-axis locating protrusions 30 are constructed to cooperate with a y-axis surface of an object (e.g., an y-axis wall of a microtiter plate), while the x-axis protrusion 25 is constructed to cooperate with an x-axis surface of the object (e.g., an x-axis wall of a microtiter plate).

The alignment members can be, for example, locating pins, tabs, ridges, recesses, or a wall surface, and the like. In presently preferred embodiments, the alignment members have a curved surface that is in contact with a properly positioned object. The use of a curved surface minimizes the effect of, for example, roughness of the object surface that contacts the alignment member. The use of two alignment members along one axis and one alignment member along the second axis, as shown in FIGS. 1 and 2, is another approach to minimize the effect of surface irregularities on the proper positioning of the object. The object is in contact with three points along the object surface, so proper alignment is not dependent upon the entire object surface being regular.

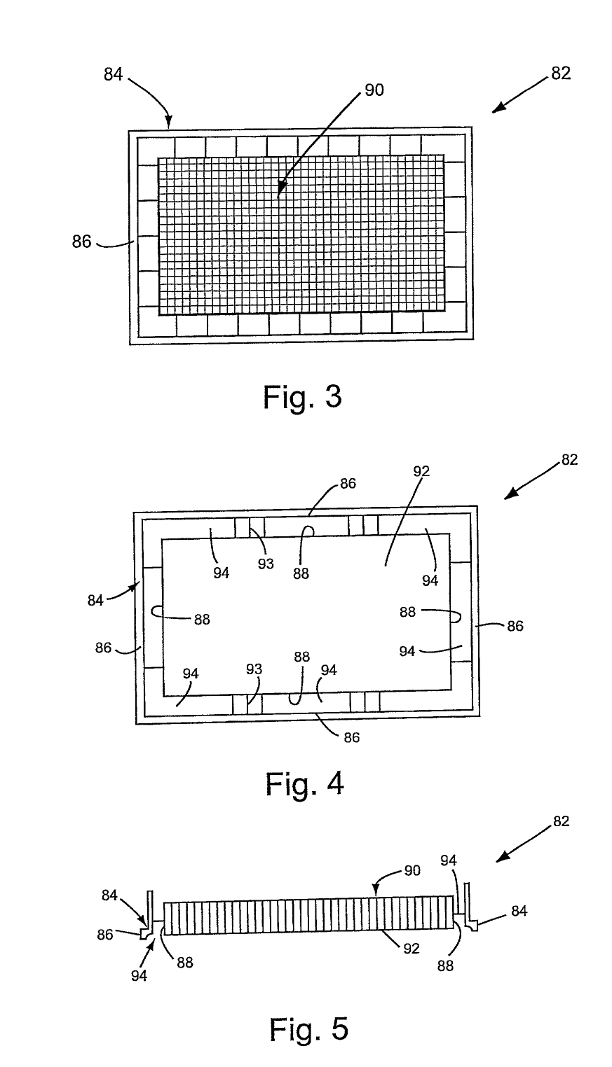

Another aspect of the invention applies specifically to positioning of microtiter plates. A microtiter plate 82 is shown in FIGS. 3, 4, and 5. The microtiter plate 82 generally comprises a well area 90 which has many individual sample wells for holding samples and reagents. Microtiter plates are available in a wide variety of sample well configurations, including commonly available plates with 96, 384, and 1536 wells. It will be appreciated that microtiter plates are available from a variety of manufacturers in a variety of configurations. The microtiter plate 82 has an outer wall 84 having a registration edge 86 at its bottom. The microtiter plate 82 has a bottom surface 92 below the well area on the plate's bottom side. The bottom surface 92 is separated from the outer wall 84 by a space 94. The space 94 is bounded by a surface of the outer wall 84 and by an inner wall 88 at the edge of the bottom surface 92. Although there may be some lateral supports 93 in the space 94, the space 94 is generally open between the inner wall 88 and an inner surface of the outer wall 84.

According to the invention, to precisely position a microtiter plate the alignment members of the object holder preferably are arranged to cooperate with an inner wall 88 of the microtiter plate. The inner wall 88 is advantageously used, as the inner wall is typically more accurately formed and is more closely associated with the perimeter of the sample well area, as compared to an outer wall of the plate 82, such as wall 84. Accordingly, aligning the microtiter plate relative an inner wall, such as inner wall 88, is generally preferred to aligning with an outer wall, such as wall 84. The increased positioning precision that is obtained by using an inner wall as the alignment surface makes possible the use of high-density microtiter plates, such as 1536 well plates. As shown in Table 1, the use of an inner well for positioning of polypropylene (A) and polystyrene (B) 1536-well plates results in much more precise positioning of the plate compared to the precision obtained using a spring clip fixture (C) such as was previously known in the art.

TABLE 1

| | | | | | | | | |
|---|---|---|---|---|---|---|---|---|
| Well Position | Axis | Plate 1 | Plate 2 | Plate 3 | Plate 4 | Plate 5 | Range | Ave |

A. PolyPro 1536 Plate (in positioning fixture)

| | | | | | | | | |
|---|---|---|---|---|---|---|---|---|
| A1 | X | -0.342 | -0.337 | -0.337 | -0.334 | -0.331 | 0.011 | -0.3362 |
| | Y | -107.195 | -107.198 | -107.206 | -107.200 | -107.203 | 0.011 | -107.2004 |
| A48 | X | -0.106 | -0.108 | -0.104 | -0.103 | -0.105 | 0.005 | -0.1052 |
| | Y | -2.640 | -2.638 | -2.628 | -2.628 | -2.631 | 0.012 | -2.6330 |
| FF48 | X | 68.893 | 68.892 | 68.903 | 68.903 | 68.905 | 0.013 | 68.8992 |
| | Y | -2.748 | -2.750 | -2.742 | -2.739 | -2.735 | 0.015 | -2.7428 |
| FF1 | X | 68.661 | 68.664 | 68.677 | 68.674 | 68.679 | 0.018 | 68.6710 |
| | Y | -107.387 | -107.385 | -107.389 | -107.390 | -107.387 | 0.005 | -107.3876 |
| P18 | X | 33.134 | 33.134 | 33.145 | 33.142 | 33.142 | 0.011 | 33.1394 |
| | Y | -69.455 | -69.456 | -69.450 | -69.456 | -69.457 | 0.007 | -69.4548 |
| P32 | X | 33.203 | 33.202 | 33.211 | 33.209 | 33.209 | 0.009 | 33.2068 |
| | Y | -38.290 | -38.295 | -38.294 | -38.294 | -38.293 | 0.005 | -38.2932 |
| Ave range | | | | | | | | |
| (mm) | | | | | | | 0.010 | |

| | Actual | Theor |
|---|---|---|
| Distance Between | 104.5674 | 105.75 |
| A1 and A48 | | |
| Distance Between | 104.6448 | 105.75 |
| FF1 and FF48 | | |
| Distance Between | 69.0072 | 69.75 |
| A1 and FF1 | | |
| Distance Between | 69.0044 | 69.75 |
| A48 and FF48 | | |

| | | | | | | | | |
|---|---|---|---|---|---|---|---|---|
| Well Position | Axis | Plate 1 | Plate 2 | Plate 3 | Plate 4 | Plate 5 | Range | Ave |

B. PolyStyrene 1536 Plate (in positioning fixture)

| | | | | | | | | |
|---|---|---|---|---|---|---|---|---|
| A1 | X | -0.361 | -0.361 | -0.362 | -0.362 | -0.362 | 0.001 | -0.3616 |
| | Y | -107.239 | -107.245 | -107.245 | -107.244 | -107.243 | 0.006 | -107.2432 |
| A48 | X | -0.106 | -0.112 | -0.116 | -0.109 | -0.107 | 0.010 | -0.1100 |
| | Y | -1.597 | -1.607 | -1.611 | -1.603 | -1.602 | 0.014 | -1.6040 |
| FF48 | X | 69.612 | 69.609 | 69.602 | 69.611 | 69.613 | 0.011 | 69.6094 |
| | Y | -1.694 | -1.703 | -1.699 | -1.697 | -1.700 | 0.009 | -1.6986 |
| FF1 | X | 69.357 | 69.357 | 69.356 | 69.356 | 69.356 | 0.001 | 69.3564 |
| | Y | -107.475 | -107.479 | -107.474 | -107.477 | -107.478 | 0.005 | -107.4766 |
| P18 | X | 33.478 | 33.476 | 33.475 | 33.477 | 33.480 | 0.005 | 33.4772 |
| | Y | -69.121 | -69.129 | -69.130 | -69.125 | -69.126 | 0.009 | -69.1262 |
| P32 | X | 33.553 | 33.549 | 33.545 | 33.552 | 33.553 | 0.008 | 33.5504 |
| | Y | -37.632 | -37.639 | -37.635 | -37.636 | -37.635 | 0.007 | -37.6354 |
| Ave range | | | | | | | | |
| (mm) | | | | | | | 0.007 | |

| | Actual | Theor |
|---|---|---|
| Distance Between | 105.6392 | 105.75 |
| A1 and A48 | | |
| Distance Between | 105.7780 | 105.75 |
| FF1 and FF48 | | |
| Distance Between | 69.7180 | 69.75 |
| A1 and FF1 | | |
| Distance Between | 69.7194 | 69.75 |
| A48 and FF48 | | |

| | | | | | | | | |
|---|---|---|---|---|---|---|---|---|
| Well Position | Axis | Plate 1 | Plate 2 | Plate 3 | Plate 4 | Plate 5 | Range | Ave |

C. PolyStyrene 1536 Plate (in spring clip fixture)

| | | | | | | | | |
|---|---|---|---|---|---|---|---|---|
| A1 | X | 117.089 | 117.093 | 117.070 | 117.085 | 117.097 | 0.027 | 117.0868 |
| | Y | -123.704 | -123.747 | -123.746 | -123.755 | -123.742 | 0.051 | -123.739 |
| A48 | X | 117.019 | 117.041 | 117.060 | 117.032 | 117.029 | 0.041 | 117.0362 |
| | Y | -18.058 | -18.093 | -18.090 | -18.100 | -18.086 | 0.042 | -18.0854 |
| FF48 | X | 186.739 | 186.759 | 186.780 | 186.752 | 186.750 | 0.041 | 186.756 |
| | Y | -17.949 | -17.991 | -18.015 | -18.002 | -17.976 | 0.066 | -17.9866 |
| FF1 | X | -186.810 | -186.813 | -186.792 | -186.803 | -186.819 | 0.027 | -186.807 |
| | Y | -123.730 | -123.783 | -123.807 | -123.795 | -123.766 | 0.077 | -123.776 |
| P18 | X | 150.816 | 150.825 | 150.819 | 150.814 | 150.824 | 0.011 | 150.8196 |
| | Y | -85.481 | -85.528 | -85.537 | -85.538 | -85.515 | 0.057 | -85.5198 |
| P32 | X | 150.792 | 150.807 | 150.813 | 150.798 | 150.802 | 0.021 | 150.8024 |
| | Y | -53.989 | -54.038 | -54.046 | -54.046 | -54.023 | 0.057 | -54.0284 |
| Ave range | | | | | | | | |
| (mm) | | | | | | | 0.043 | |

These results demonstrate that the use of the inner wall of the microtiter plate as an alignment surface results in much more precise and reproducible positioning of the microtiter plate on a support than use of an outer wall of the microtiter plate.

Further, by having the alignment members (e.g., alignment protrusions 25 and 30) cooperate with an inner wall 88 of the plate 82, minimal structures are needed adjacent the outside of the plate. In such a manner, a robotic arm or other transport is able to readily access the plate 82. Having the protrusions positioned adjacent the inner wall 88 thereby facilitates more easily transporting the plate 82. However, it will be appreciated that the protrusions can be placed in alternative positions and still facilitate the precise positioning of the plate.

The object holders of the invention generally include one or more movable members. The movable members function to move an object against one or more alignment members. For example, once an object is placed in the general location of the alignment member(s), the movable members (termed “pushers” herein) move the object so that an alignment surface of the object is in contact with one or more of the alignment members of the object holder. The object holder can have pushers for positioning of the object along one or more axes. For example, an object holder will often have one or more pushers that position an object along an x-axis, and one or more additional pushers that position the object along a y-axis. The pushers can be moved by means known to those of skill in the art. For example, springs, pistons, elastic members, electromagnets or other magnets, gear drives, and the like, or combinations thereof, are suitable for moving the pushers so as to move the object into a desired position.

One embodiment of an object holder having pushers for positioning a microtiter plate along both the x-axis and the y-axis is shown in FIGS. 1 and 2. When the microtiter plate is generally positioned adjacent the x and y-axis protrusions, the bottom surface of the microtiter plate is directly above the top surface 22 of the vacuum plate 20. A y-axis pusher 35, which extends through a slot 40 in the fixture 15, is used to apply pressure to a y-axis side wall of the microtiter plate. Sufficient force is applied to the plate at the plate contact 45 to push the microtiter plate against the y-axis protrusions 30. When the microtiter plate is pushed against the y-axis protrusions 30, an x-axis pusher 50, which extends through slot 55 of the fixture, is used to push an x-axis wall of the microtiter plate towards the x-axis protrusion 25. In such a manner, the microtiter plate is accurately and precisely positioned relative both the x-axis and y-axis protrusions. It is sometimes advantageous, although not necessary, to have one or more of the pushers contact an inner wall of a microtiter plate rather than an outer wall. With this arrangement, the alignment members and pushers are underneath the microtiter plate. This leaves the area surrounding the exterior of the plate free of protrusions that could otherwise interfere with other devices that, for example, place the microtiter plate on the support.

The object holder embodiment shown in FIGS. 1 and 2 has a vacuum plate that functions as a retaining device to hold a properly positioned object in the desired position. With both the y-axis pusher 35 and the x-axis pusher 50 applying sufficient force to precisely place the microtiter plate, a vacuum source (not shown) applies a vacuum through vacuum line 65 into vacuum holes 60.

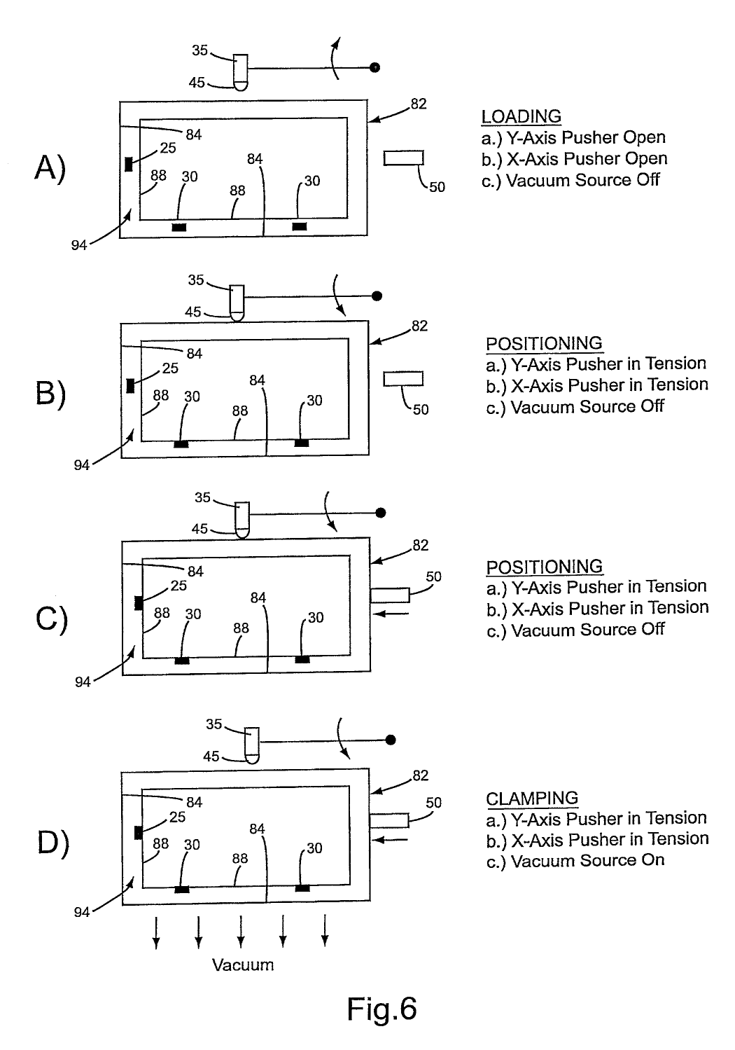

Referring now to FIGS. 6A-D, one embodiment of a general progression of positioning an object in the object holder 10 is described. It is recognized that the object holder can employ means that are equivalent to those illustrated to move an object into a desired position on the surface. Similarly, although the figures demonstrate the positioning of a microtiter plate in particular, one can readily adapt the arrangement of the object holder components to position objects other than microtiter plates. FIG. 6 shows a simplified bottom view of a microtiter plate 82 resting on the vacuum plate (not shown). FIG. 6A shows a loading position where the microtiter plate 82 is generally positioned relative the x-axis and y-axis protrusions 25 and 30. When generally positioned, the microtiter plate 82 is positioned such that the y-axis protrusions 30 are received into the opening 94 along the y-axis edge of the microtiter plate and the x-axis protrusion 25 is received into the space 94 along the x-axis edge of the microtiter plate. Accordingly, in this presently preferred embodiment the protrusions are positioned in the space 94 between the inner wall 88 and the outer wall 84. It will be appreciated that the protrusions may cooperate with the microtiter plate in alternative configurations to place the microtiter plate in a generally positioned orientation. Further, to facilitate loading, both the y-axis pusher 35 and the x-axis pusher 50 are positioned away from the microtiter plate 82.

Referring now to FIG. 6B, the y-axis pusher 35 is moved so as to contact an outer y-axis edge of the microtiter plate 82. As described above, the pusher could also be arranged to contact an inner well surface of the microtiter plate. The y-axis pusher 35 is moved with sufficient force to firmly force the plate contact 45 against a wall 84 of the microtiter plate 82. As the y-axis pusher 35 is pressed against the microtiter plate 82, the microtiter plate is moved, if necessary, to firmly position the inner wall 88 against the y-axis protrusions 30. As the y-axis pusher 35 generally contacts the y-axis edge of the microtiter plate in a central location, the microtiter plate is moved with a minimum skewing force. In such a manner the microtiter plate is firmly and reliably positioned in the y-axis.

With the microtiter plate 82 firmly positioned in the y-axis, FIG. 6C shows that the x-axis pusher 50 is moved against an x-axis wall of the microtiter plate 82. In such a manner the x-axis pusher 50 moves the microtiter plate 82 to position the inner wall 88 against the x-axis protrusion 25. While the x-axis pusher 50 is moving and holding the plate against the x-axis alignment member, the y-axis pusher 35 remains firmly pressed against the y-axis wall of the microtiter plate 82. To facilitate the microtiter plate 82 moving in the x direction relative the contact 45, the contact 45 is preferably constructed to be a low friction element. For example, the low friction contact point 45 can be mounted on a spring-loaded member, which can keep a constant force against the microtiter plate 82 while enabling the microtiter plate to be moved in the x-axis by the x-axis pusher 50. FIG. 10 shows an example of a suitable spring-loaded member. The contact point can also be coated with a low-friction material, such as TEFLON™, and the like. A low friction contact point can also be constructed by using a rolling contact point, for example, or other means to reduce friction. A DELRIN™ ball plunger is another example of a suitable low friction contact point.

As shown in FIG. 6D, when the microtiter plate 82 has moved into position by the x-axis pusher 50, the microtiter plate is precisely positioned for further processing. With the plate precisely positioned, a vacuum source (not shown) is activated, thereby securely drawing the microtiter plate 82 against a vacuum plate. Accordingly, the microtiter plate 82 is securely retained in its precise position, thereby allowing accurate and reliable further processing.

Retaining Devices

The invention also provides retaining devices for retaining an object, such as a microtiter plate, in a desired position on the support. These retaining devices of the invention include a vacuum plate upon which the object is placed. The vacuum plate generally has a top surface upon which the object to be retained is placed. One or more openings are present through which air can be withdrawn from the space between the top surface of the vacuum plate and the bottom surface of the object. The opening or openings can be connected to a vacuum source. When the object is properly positioned on the support and a vacuum is applied, an airtight seal is formed between the object and the vacuum plate, thus holding the object in the desired position. For example, if the object is a microtiter plate, the bottom surface of the microtiter plate forms a seal with the top surface of the vacuum plate.

An example of a retaining device of the invention is shown in FIGS. 1, 2 and 8. In this embodiment, the vacuum plate 20 has a top surface 22 which generally comprises a central interior area 69 and a lip area 67 which are separated by the vacuum groove 63. When the object is generally positioned in the desired position, a bottom surface of the object rests on the lip area 67 of the top surface 22. A vacuum source (not shown) applies a vacuum through vacuum line 65 into vacuum holes 60. The vacuum holes 60 are in communication with a vacuum groove 63 which generally is positioned inside the perimeter of the vacuum plate 20. In such a manner, the vacuum effect is transferred around the entire perimeter of the plate. As the vacuum effect draws the bottom surface of the object towards the top surface 22 of the vacuum plate 20, the object is retained by the vacuum force to the vacuum lip 67 and the interior vacuum plate 69.

In the example illustrated in FIGS. 1, 2 and 8, the retaining device 20 is provided as a rectangular vacuum plate, with a y-axis length constructed longer than an x-axis length. This particular vacuum plate 20 is sized and constructed to cooperate with a bottom surface of a microtiter plate to retain the microtiter plate securely against a top surface 22 of the vacuum plate 20 when a vacuum source is activated. The vacuum plate also can be configured to retain objects other than microtiter plates. For example, the vacuum plate can be shaped to form a suction with any flat surface of an object. A rectangular slot, for example, can be used to retain an object having a flat rectangular surface.

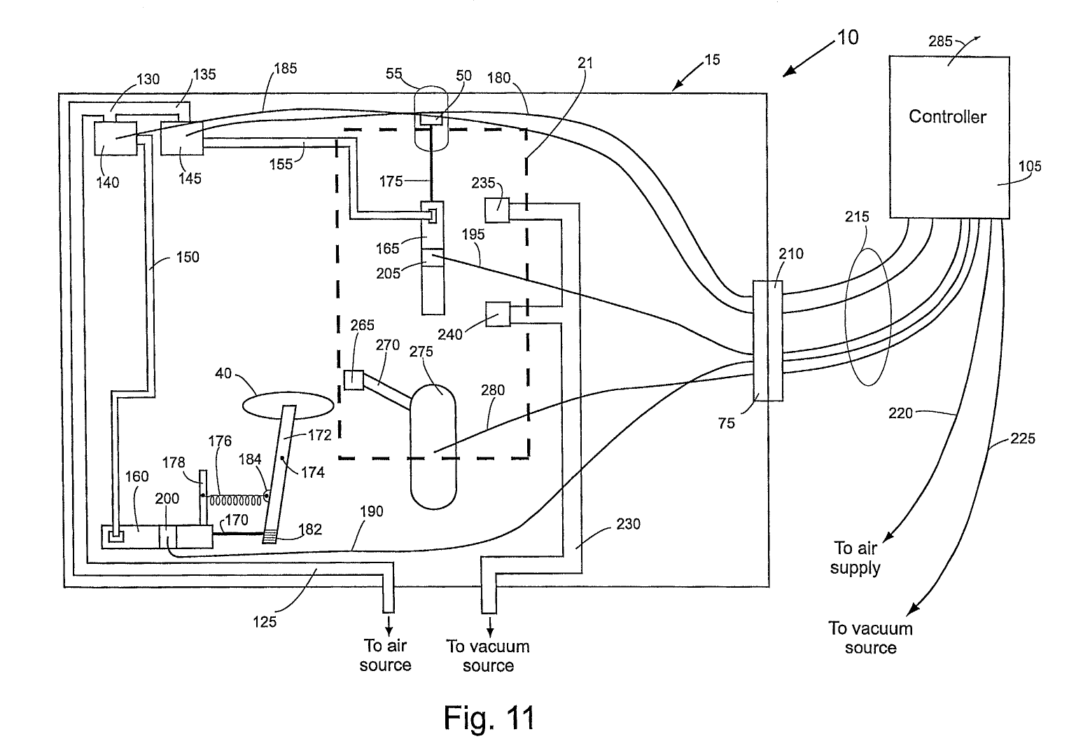

FIG. 11 shows one embodiment of the retaining device of the invention. A vacuum source (not shown) connects to vacuum line 230 which connects to vacuum inlets 240 and 235. The vacuum line inlets 235 and 240 are directly connected into vacuum holes which extend through the vacuum plate and communicate with the vacuum groove. In a presently preferred embodiment, the vacuum holes are positioned adjacent the perimeter of the vacuum plate and use a vacuum groove to communicate the vacuum around the perimeter of the vacuum plate. It will be appreciated that other positioning of the vacuum holes and other arrangements can be used to improve the vacuum sealing capability of the vacuum plate.

Objects sometimes have lower surface imperfections that can interfere with the formation of an airtight seal between the vacuum plate and the object surface, Such imperfections can include, for example, warping, height variations, and other structural imperfections. For example, the bottom surface of a microtiter plate may bow slightly so that the center portion of the microtiter plate extends below the perimeter edge of the microtiter plate. Accordingly, if such a bowed plate is placed on the vacuum plate 20, the bowed portion of the microtiter plate can contact the interior plate area 69 and not allow a perimeter edge of the plate to fully engage the lip area 67. In such a manner, when vacuum is applied to the vacuum channel 63, a gap sufficient to avoid vacuum sealing may remain between the perimeter edge of the microtiter plate and the lip area 67. With such a gap, it may not be possible to vacuum seal the microtiter plate to the vacuum plate.

To accommodate such imperfections in microtiter plates and other objects, the interior vacuum surface 69 may be recessed slightly below the vacuum lip 67. By recessing the interior surface 69 slightly, the probability that the perimeter edge of the microtiter plate will fully contact the lip area 67 is increased. The depth and other dimensions of the recess will depend upon the expected variations in the bottom surface of the objects. Typically, the depth of the recess is between about 0.001 and 0.01 inches. For microtiter plates, the interior vacuum area is preferably positioned about 0.002 inches below the top surface of the lip 67 because it has been found that the 0.002-inch variation in height is not sufficient to disrupt the sample wells when the microtiter plate is sealed to the vacuum plate 20. Another approach by which to avoid distortion of the object, the recessed area can be partially or completely filled with a porous matrix material or other support members (e.g., ribs) that provide support for the bottom surface of the object while still allowing formation of a vacuum seal. The use of a support allows the use of a recess of greater depth, if desired.

The retaining devices of the invention can also include sensing switches or other means for sensing whether a vacuum effect is present between an object and the vacuum plate. For example, FIG. 2 shows a vacuum switch hole 80, which in this particular embodiment is positioned at the base of the vacuum groove 63. The vacuum switch hole communicates the vacuum level to a vacuum sensing switch, which confirms a sufficient level of vacuum beneath the object. In such a manner, the vacuum force retaining the object can be measured and monitored while the object is retained against the vacuum plate 20. If the vacuum level is insufficient, the sensing switch can send a signal to a controller, or to a human operator, that the object is not properly positioned and/or retained and thus is not ready for further processing. Conversely, if a vacuum is sensed, the switch can signal the controller to proceed with further processing.

An example of a retaining device that includes a sensing device is shown in FIG. 11, which generally shows a bottom side of a fixture 15 with the vacuum plate 20 positioned on the top surface of the fixture 15. Although from the bottom view in FIG. 1 the vacuum plate is not visible, dotted line 21 shows the general positioning of the vacuum plate 20 on the other side of the fixture 15. As shown, a vacuum switch hole is positioned in the vacuum groove. The vacuum switch hole communicates with vacuum switch inlet 265, which connects to vacuum switch 275 through vacuum switch line 270. The vacuum switch 275 electrically connects to a controller 105 through control line 280 for communicating status of vacuum to the controller. In that regard, the controller 105 receives a signal when sufficient vacuum is achieved at the vacuum plate to draw the microtiter plate firmly against the vacuum plate. The controller 105 can also communicate to the vacuum source via control line 225 and optionally to a air supply source (described below) via control line 220. The controller 105 can also receive direction and send status information to other system components via system connection line 285.

Once the vacuum source has securely retained the microtiter plate or other object against the vacuum plate 20, additional processes may be performed reliably and accurately to the microtiter plate. When processing of the microtiter plate or other object is completed, the vacuum source is deactivated, thereby releasing the object from the vacuum plate 20.

Integrated Object Holder Systems

The invention also provides object holders that integrate two or more of the devices described herein for positioning and retaining objects on a support. For example, the invention provides object holders that utilize pushers and alignment members to precisely position an object, and a vacuum plate as a retaining device to hold the object in the desired position. These integrated object holders typically have an control system that coordinates the actions of the different components of the object holder.

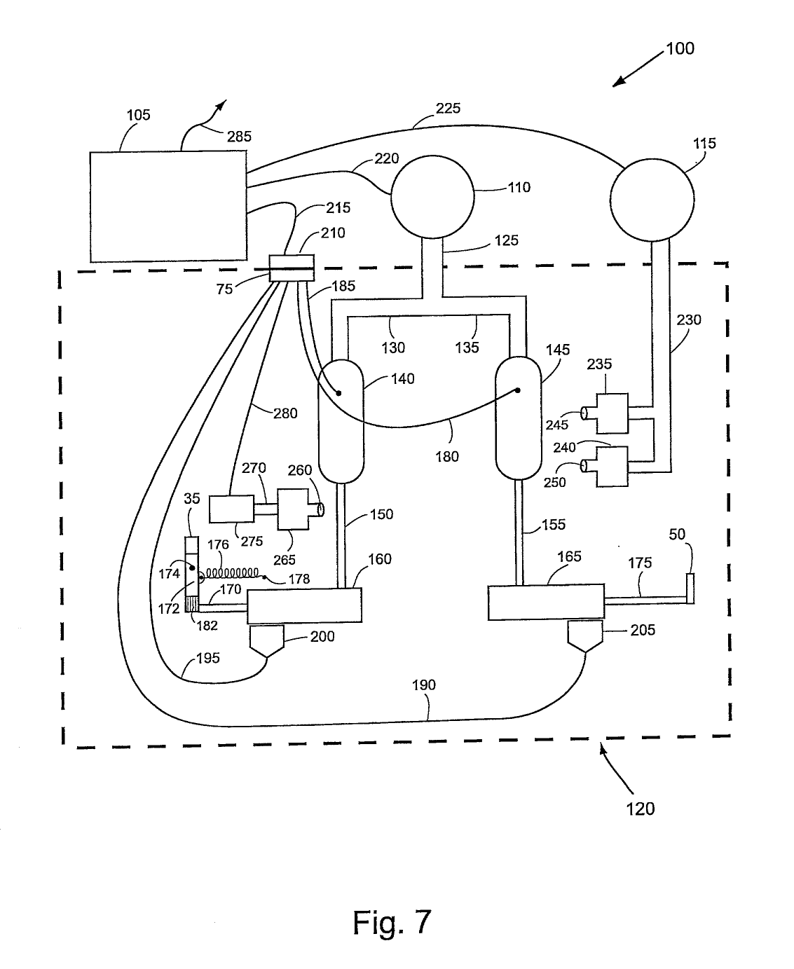

FIG. 7 shows one example of a control system 100 for object holder 10. Control system 100 generally comprises a controller 105 connected to a plate holder 120 through a plate holder control line 215. The plate holder control line 215 may terminate in a connector 210 to facilitate connection to a mating control connector 75 on the plate holder 120. This arrangement facilitates connection and disconnection of the components. The controller 105 may also be connected to other system components in a high throughput test system through system connection line 285. For example, the controller 105 matrices instructions from a central control system and report status information in return.

The controller 105 in this embodiment also controls a vacuum source 115 through vacuum source control line 225 and optionally controls an air supply 110 via air supply control line 220. In such a manner, the controller can accept instructions or send status information to a high throughput test system controller and control and monitor the precise positioning of a microtiter plate.

In some embodiments, both the x-axis pusher 50 and the y-axis pusher 35 are activated by air pistons. The air supply 110 provides pressurized air through air supply line 125 which is directed into a y-axis air supply line 130 and an x-axis air supply line 135. The y-axis air supply line 130 is received into a y-axis air switch 140 which acts as a valve to open or close the y-axis supply line 130. The y-axis air switch is directed by the controller 105 through x-axis air switch control line 185. When the controller 105 directs the y-axis air switch 140 to an open position, air pressure is received into the y-axis piston air supply line 150. The y-axis piston air supply line 150 is connected to the y-axis air piston 160, which drives a y-axis arm 170. It will be appreciated that other mechanisms may be used to activate the pushers, such as hydraulic rams, electromagnetic actuators, or gear drives, for example.

The y-axis arm 170 drives a lever 172 around a pivot 174. Accordingly, when the air piston 160 is activated, the y-axis pusher pin 35 is moved from its at-rest position. The at-rest position is defined by the spring 176 which attaches between the lever 172 and a spring support 178. In such a manner the spring 176 causes the lever 172 to pivot from pivot point 174. In a preferred embodiment of the object holder 10, when the air piston 160 is not active, the spring causes the y-axis pusher 35 to be firmly engaged against the microtiter plate. Thereby when the air piston 160 is activated, the y-axis pusher 35 is moved away from a wall of the microtiter plate.

The air piston 160 has a y-axis magnet switch 200 that communicates y-axis arm position 170 to the controller 105 via magnetic switch control line 195. In such a manner the controller receives a signal indicating the status of the position of the y-axis arm 170. For example, a signal may be placed on line 195 when the air piston 160 has moved the y-axis arm 170 in a position that fully disengages the y-axis pusher 35 from the microtiter plate.

The X-axis air switch 145 is connected to controller 105 through x-axis air switch control line 180. When the controller 105 directs the x-axis air switch 145 to activate, air pressure is placed in x-axis piston air supply line 155. Such air pressure drives the x-axis arm 175 of the x-axis air piston 165. X-axis magnetic switch 205 communicates to controller 105 through magnetic switch control line 190 to generate a signal that indicates the position of x-axis arm 175. In a preferred example, the x-axis air piston 165 is configured to retract the x-axis pusher 50 when the air piston 165 is deactivated and to force the x-axis pusher 50 against the microtiter plate when the x-axis air piston 165 is activated. When the x-axis air piston 165 is activated and the x-axis pusher 50 is driven firmly against the microtiter plate, the magnetic switch 205 may generate a signal on line 190 which indicates to the controller 105 that the microtiter plate 82 is firmly positioned in the x-axis.

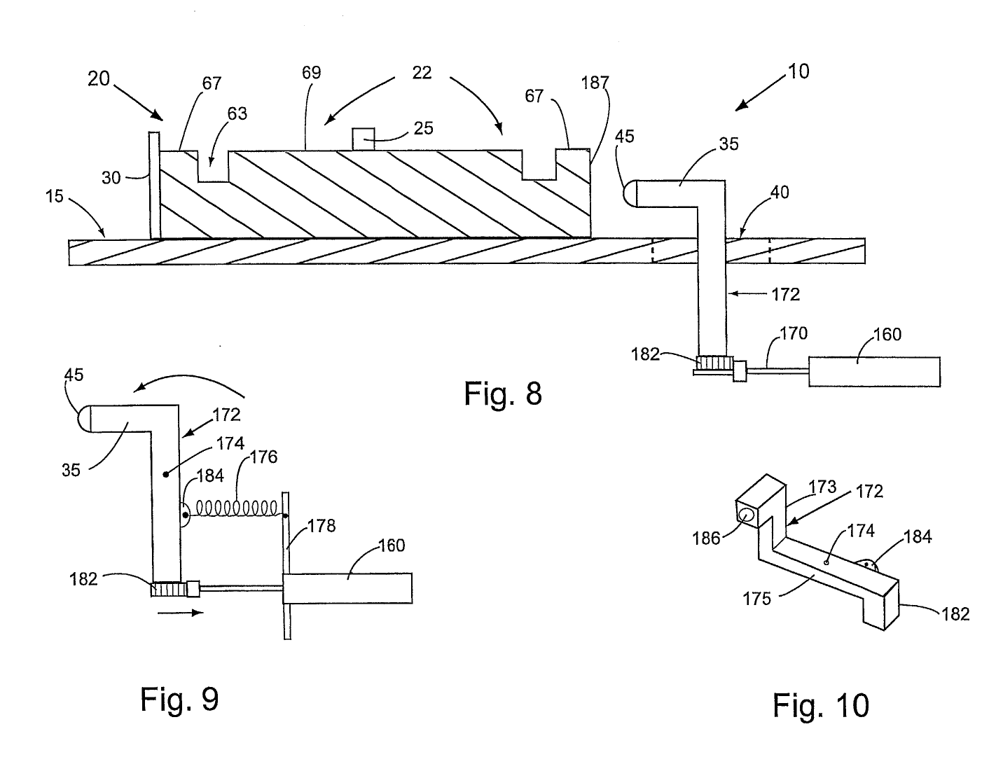

Referring now to FIGS. 8, 9, and 10, the operation of one embodiment of the y-axis pusher is detailed. The y-axis pusher 35 in this embodiment is a generally L-shaped member having a vertical portion 173 and a horizontal portion 175. A contact connector 186 is positioned at the top end of the vertical portion 173 for attaching the plate contact 45. The horizontal portion 175 extends at a right angle from the vertical portion 173 and ends with an enlarged arm contact 182. The arm contact 182 is constructed and arranged to cooperate with the y-axis arm 170 of the y-axis piston 160. In a presently preferred arrangement the y-axis arm 170 terminates with an adjustment mechanism for adjusting the length of the y-axis arm.

The horizontal portion 175 of the lever 172 has a pivot 174 for receiving a pivot pin that enables the y-axis pusher 35 to pivot about the pivot point 174. The horizontal portion 175 also has a spring connector 184 for receiving one end of the spring 176. The other end of spring 176 is connected to a stable support such as stable support 178. In a preferred configuration the spring support 178 is attached to the y-axis air piston and the fixture. When the spring 176 is connected between the spring contact 184 and the stable support 178, the spring acts to draw the arm contact 182 towards the air piston 160. As in the illustrated example the lever 172 is configured to pivot about pivot point 174, the plate contact 45 is rotated in a direction generally away from the air piston.

In the illustrated embodiment, when the air piston 160 is not activated, the spring 176 acts to press the plate contact 45 toward the y-axis wall 187 of the vacuum plate 20. If a microtiter plate (not shown in FIGS. 8, 9 or 10) is generally positioned on the vacuum plate 20, the plate contact 45 contacts a y-axis wall of the microtiter plate and pushes the plate toward the y-axis protrusions 30. For optimum positioning performance, the y-axis pusher 35 should provide a constant and stable positioning force to the y-axis wall of a microtiter plate. To assure a constant pressure, the force exerted by the y-axis pusher 35 is determined by the spring 176. As springs inherently provide a constant and deterministic force, the microtiter plate will be positioned with a known and constant tensioning force.

In the preferred embodiment, after the microtiter plate is positioned to the y-axis, the y-axis pusher continues to exert a force against the y-axis wall of the microtiter plate. When the x-axis pusher is activated, the x-axis pusher 50 moves the microtiter plate towards the x-axis protrusion 25. Accordingly, the microtiter plate is moved relative the plate contact 45 and the lever 172 while the y-axis pusher continues to exert a force against the microtiter plate. In that regard the lever 172 must maintain stability in the x-axis direction to avoid skewing and maintain a constant and stable y-axis force. To achieve such stability for lever 172, lever 172 is constructed as a pivoting lever which pivots about pivot point 174. Since the pivot point 174 and the plate contact 45 are generally aligned with the x-axis of the microtiter plate, the pivot acts to substantially stabilize the x-axis positioning of the plate contact 45. Accordingly, when the y-axis pusher 35 is fully tensioned the microtiter plate, and the x-axis pusher moves the microtiter plate towards the x-axis protrusions 25, the y-axis pusher 35 maintains a constant and stable y-axis force. Skewing is also avoided by constructing the plate contact 45 to have a low-friction contact point with the microtiter plate.

Although in the preferred embodiment, the y-axis pusher is configured as a pivoting lever, it will be appreciated that other configurations may be used to move a microtiter plate towards y-axis protrusions. For example, the plate contact 45 could be directly attached to an air piston arm with the air piston being driven by a constant and stable air force to move the plate contact stably and constantly toward the microtiter plate wall.

Once the vacuum source has securely retained the microtiter plate against the vacuum plate 20, additional processes may be performed reliably and accurately to the microtiter plate. When processing of the microtiter plate is completed, the vacuum source is deactivated, thereby releasing the microtiter plate from the vacuum plate 20. Subsequently, the x-axis pusher 50 is released and the y-axis pusher 35 is released. With the vacuum off and the pushers released, the microtiter plate can be easily lifted from the object holder 10 for further processing.

Referring now to FIG. 11, one example of a preferred arrangement of parts is shown for an object holder 10. FIG. 11 generally shows a bottom side of the fixture 15 with the vacuum plate 20 positioned on the top surface of the fixture 15. Although from the bottom view in FIG. 11 the vacuum plate is not visible, dotted line 21 shows the general positioning of the vacuum plate 20 on the other side of the fixture 15.

An air source (not shown) is connected to the air supply 125 which runs generally on the perimeter of the fixture to the y-axis air supply line 130 and the x-axis air supply line 135. The y-axis air supply line 130 connects to the y-axis air switch 140 and the x-axis air supply line 135 connects to the x-axis air switch 145. The air switches 140 and 145 electrically connect via electrical lines 185 and 180 to electrical connector 75, and then connect to the controller 105 through connector 210 and control line 215. Accordingly, the controller can then direct the air switches to activate or deactivate the air pistons. For example, the controller can direct y-axis air switch 140 to activate, thereby pressurizing y-axis air supply line 150 and driving the arm 170 of air piston 160. When the arm 170 is driven, the lever 172 pivots about pivot point 174 and pulls the y-axis pusher lever away from the vacuum plate. When the controller deactivates the y-axis air switch 140, air bleeds from the piston 160 and the spring 176, which is under tension between spring contact 184 and stable support 178, tensions the y-axis pusher towards the vacuum plate. Magnetic switch 200 communicates to the controller 105 through control line 190 for indicating y-axis pusher position.

The controller also controls x-axis air switch 145, which when opened pressurizes x-axis piston air supply line 155 for driving the x-axis arm 175 of x-axis air piston 165. Accordingly, the x-axis pusher 50 is propelled toward the vacuum plate 20. In a preferred embodiment, the x-axis pusher is directly attached to the x-axis arm 175. It will be appreciated that other configurations and arrangements may be used for attaching the x-axis pusher to the x-axis arm. To conserve space, the x-axis piston is arranged so that the arm 175 is pulled into the piston body 165 when air pressure is applied to the piston 165. When pressure is released, the arm 175 travels in a manner so that the x-axis pusher 50 is released from any retained microtiter plate. Magnetic switch 205 connects to controller 105 via line 195 so that the controller 105 can receive a signal that the x-axis pusher 50 is fully engaged against the microtiter plate.

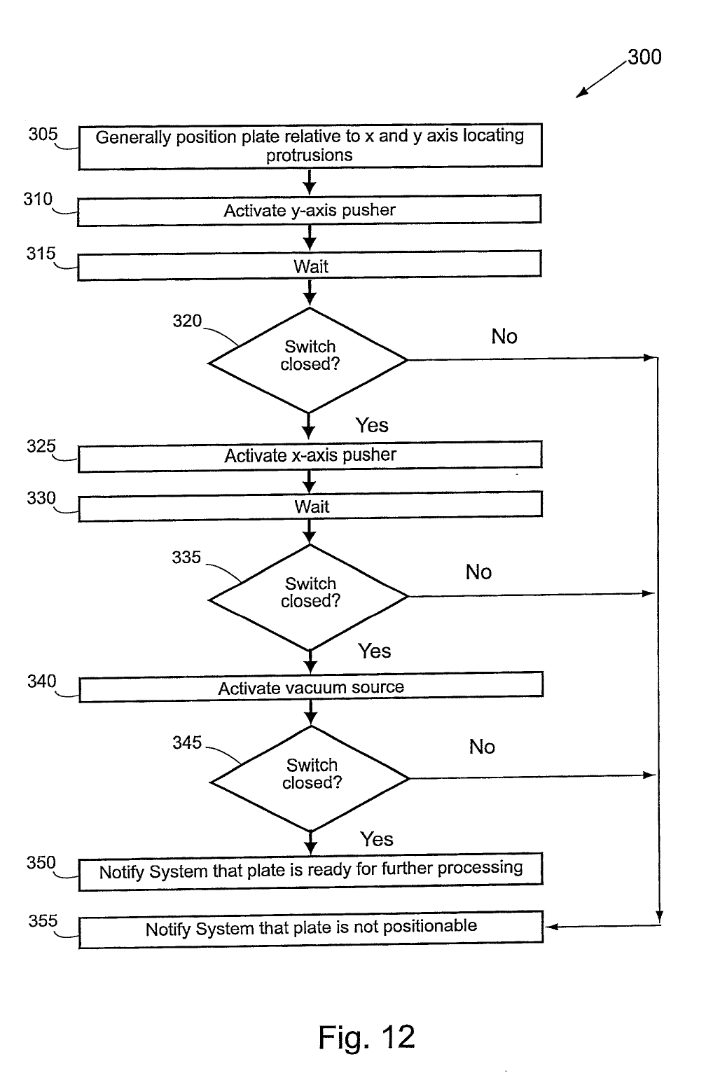

Referring now to FIG. 12, a method of retaining a microtiter plate 300 is shown. In block 305, the microtiter plate is generally positioned relative to x and y locating protrusions. To facilitate ease of general positioning, both the x-axis and the y-axis pushers are positioned away from the microtiter plate. In the preferred embodiment, the y axis air piston is active and the x axis piston not active to position the protrusions away from the plate. It will be appreciated that other arrangements may be substituted.

The plate can be generally positioned using any conventional means, including robotic positioning. Although such general robotic positioning may be sufficient to place the plate adjacent the protrusions, such general positioning is not sufficiently accurate for high throughput automated use. Once the plate is generally positioned, the object holder may receive a signal that the plate is generally positioned and ready to be precisely positioned in a desired orientation.

Block 310 shows that the y-axis pusher is positioned in tension against a y-axis wall of the microtiter plate. In a preferred arrangement, the y-axis pusher is released to an at-rest position where a spring provides a constant and determined tension between the y-axis pusher and the microtiter plate. When the y-axis pusher is released, the y-axis pusher comes into tensioned contact with a y-axis wall of the microtiter plate. As the y-axis pusher is tensioned against the y-axis wall of the microtiter plate, the microtiter plate is pushed firmly against the y-axis protrusions. As a short period of time may be required to constantly tension and move the microtiter plate, the system waits for the system to settle in block 315.

The y-axis pusher may have an indication of when the y-axis pusher is in a particular position. If such a indicator is used, the indicator may be, for example, a switch which closes when the y-axis pusher is in position. In a preferred embodiment, the switch is a magnetic switch coupled to an air piston moving the y-axis pusher. It will be appreciated that other sensors or indicators may be substituted. Accordingly, block 320 checks to see if the switch is closed, and if the switch is closed, the x-axis pusher is activated in block 325. If the switch does not close in the allotted time, the system is notified that the microtiter plate is not positionable in block 355, and the process would typically be aborted.

With the x-axis pusher activated in block 325, the x-axis pusher is moved toward the microtiter plate, thereby positioning the microtiter plate firmly against the x-axis protrusion. As moving the microtiter plate in the x-axis direction may take a period of time, the system waits in block 330. As with y-axis pusher, the x-axis pusher may have an indicator of when the x-axis pusher is firmly in position. Accordingly, block 335 checks to see if this indicator switch is closed, and if it is closed, the vacuum source is activated in block 340. However, if the switch does not close, the system is notified that the plate is not positionable in block 355.

In block 340, the vacuum source is activated, causing the vacuum lines to withdraw air from the vacuum plate area. The vacuum source will preferably cause the bottom surface of the microtiter plate to be drawn to the vacuum plate in a secure manner. The vacuum plate may have a vacuum switch for determining when sufficient vacuum has been created to securely retain the microtiter plate. If the vacuum switch is not closed, then block 345 directs the system to be notified that the plate is not properly positioned. However, if the vacuum switch does close, this is a positive indication that the microtiter plate is firmly and precisely positioned, and therefore the system is notified in block 350 that the plate is ready for further processing.

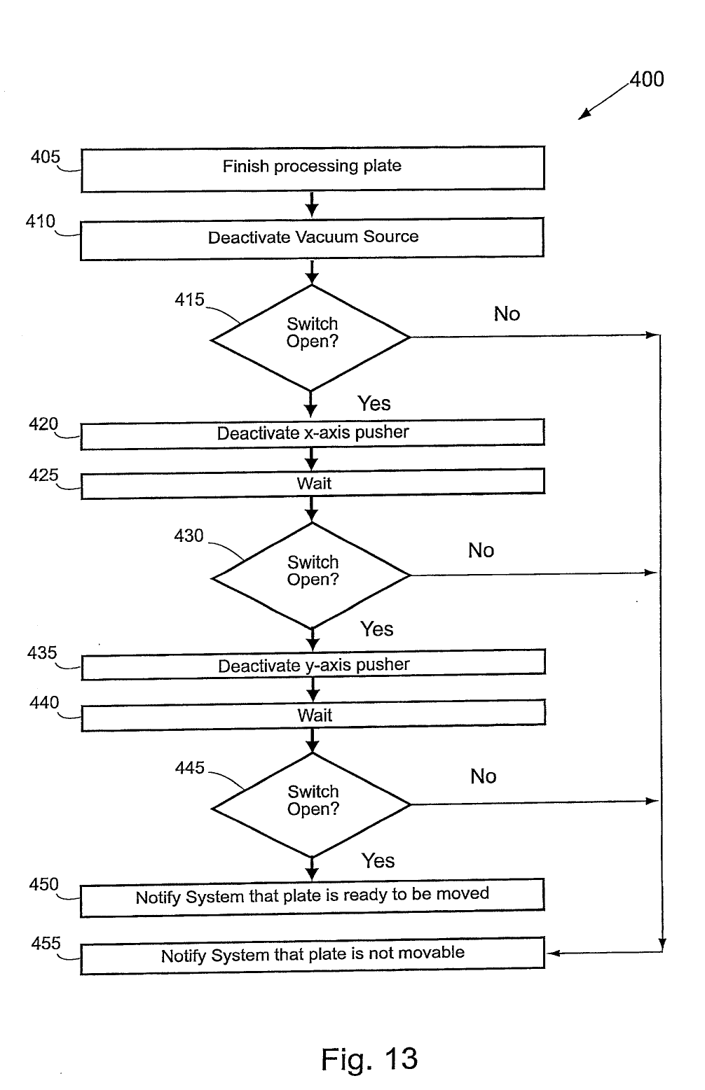

Referring now to FIG. 13, one embodiment of a method of releasing a microtiter plate is described, which is essentially the reverse process of that described in the method of retaining the plate 300. Block 405 shows that the microtiter plate has finished processing and the system is notified that the microtiter plate can now be removed. In block 410, the vacuum source is deactivated, which should open the vacuum switch 275 shown in FIG. 11. If the switch does open, then the x-axis pusher is deactivated in block 420, and after a period of time, the switch is checked in block 430 to verify that the x-axis pusher has moved. If the x-axis pusher has moved, then the y-axis pusher is activated to move the y-axis pusher away from the microtiter plate. After a period of time, the switch should open thereby indicating the y-axis pusher is moved away from the microtiter plate. If the switch does properly open, then the system is notified that they plate is ready to be moved. Accordingly, another robotic system can be used to grip the plate and move the plate to a next station for processing. If any of the switches do not indicate properly, then the system is notified that the plate is not moveable in block 455. In that regard, manual intervention will probably be used to remove the plate.

The invention also provides algorithms and computer software for programming a controller to automatically carry out the described object positioning and/or retention procedures described herein. Also provided are computers that are programmed to carry out one or more of the positioning and retention procedures.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes.

We claim:

1. A positioning device for precisely positioning a microtiter plate on a support, wherein the positioning device comprises at least a first alignment member that is positioned to contact an inner wall of the microtiter plate when the microtiter plate is in a desired position on the support.

2. The positioning device of claim 1, wherein two or more alignment members are positioned to contact a single inner wall of the microtiter plate when the microtiter plate is in the desired position on the support.

3. The positioning device of claim 1, wherein the positioning device further comprises at least a second alignment member that is positioned to contact a second wall of the microtiter plate when the microtiter plate is in the desired position on the support.

4. The positioning device of claim 3, wherein the second wall of the microtiter plate is an inner wall.

5. The positioning device of claim 4, wherein the first inner wall and the second inner wall form a right angle.

6. The positioning device of claim 4, wherein two or more alignment members are positioned to contact the first inner wall of the microtiter plate, and at least a third alignment member is positioned to contact the second inner wall, when the microtiter plate is in the desired position on the support.

7. The positioning device of claim 1, wherein one or more of the alignment members comprises a curved surface that contacts the inner wall of the microtiter plate.

8. The positioning device of claim 7, wherein one or more of the alignment members comprises a locating pin.

9. The positioning device of claim 1, which further comprises a pusher that can move a microtiter plate in a first direction to bring a first inner wall of the microtiter plate into contact with one or more of the alignment members.

10. The positioning device of claim 9, wherein the positioning device comprises a second pusher that can move the microtiter plate in a second direction to bring a second inner wall of the microtiter plate into contact with one or more of the alignment members.

11. The positioning device of claim 10, wherein the device comprises two alignment members that are in contact with the first inner wall of a microtiter plate when the microtiter plate is in a desired position.

12. The positioning device of claim 1, wherein the positioning device comprises a retaining device which retains the microtiter plate in the desired position on the support.

13. The positioning device of claim 12, wherein the retaining device comprises a vacuum plate.

14. A retaining device for retaining a microtiter plate in a desired position on a support, wherein the retaining device comprises a vacuum plate which, when a vacuum is applied, holds the microtiter plate in the desired position.

15. The retaining device of claim 14, wherein the vacuum plate is connected to a vacuum source.

16. The retaining device of claim 14, wherein the vacuum plate comprises an interior surface and a lip surface, with the interior surface being recessed relative to the lip surface.

17. The retaining device of claim 16, wherein the depth at which the interior surface is recessed is between 0.001 inches and 0.01 inches.

18. The retaining device of claim 16, wherein a support matrix approximately as thick as the depth at which the interior surface is recessed is present on the interior surface to prevent distortion of the microtiter plate when a vacuum is applied.

19. The retaining device of claim 14, wherein the device comprises a vacuum-actuated switch that, when the microtiter plate forms an airtight seal with the vacuum plate, generates a signal that the microtiter plate is properly positioned.

20. The retaining device of claim 19, wherein the signal notifies a controller that the microtiter plate is ready for further processing.

21. An object holder for precisely positioning an object on a support, wherein the object holder comprises:
a first pusher for moving the object in a first direction so that a first alignment surface of the object contacts a first set of one or more alignment members; and
a second pusher for moving the object in a second direction so that a second alignment surface of the object contacts a second set of one or more alignment members; wherein
wherein the first pusher comprises a lever pivoting about a pivot point.

22. The object holder of claim 21, wherein the lever is operably attached to a spring which causes the pusher to apply a constant force to the object in order to move the object in the first direction against the first set of alignment members.

23. The object holder of claim 21, wherein the first pusher comprises a low friction contact point which contacts the object, thus facilitating movement of the object in the second direction by the second pusher.

24. The object holder of claim 23, wherein the low friction contact point is a roller.

25. The object holder of claim 21, wherein the object is a microtiter plate.

26. The object holder of claim 25, wherein either or both of the first alignment surface and the second alignment surface is an inner wall of the microtiter plate.

27. The object holder of claim 21, wherein the object holder comprises one or more sensors that detect the position of one or more of the pushers, thereby determining whether the object is in a desired position.

28. The object holder of claim 21, wherein the object holder comprises a controller that first directs the first pusher to move the object in a first direction, then directs the second pusher to move the object in a second direction, and subsequently directs a retaining device to be activated.

29. An automated system for performing high-throughput assays or reactions in microtiter plates, wherein the automated system comprises a positioning device of claim 1.

30. The automated system of claim 29, wherein the automated system comprises a robotic device for placing a microtiter plate on the positioning device.

31. The automated system of claim 29, wherein the automated system comprises a liquid dispenser which can deposit reagents in wells of a microtiter plate.

32. An automated system for performing high-throughput assays or reactions in microtiter plates, wherein the automated system comprises a retaining device of claim 14.

33. The automated system of claim 32, wherein the automated system comprises a robotic device for placing a microtiter plate on the positioning device.

34. The automated system of claim 32, wherein the automated system comprises a liquid dispenser which can deposit reagents in wells of a microtiter plate.

35. An object holder for receiving and retaining an object in a desired orientation, the object having a first alignment surface and a second alignment surface, the object holder comprising:
a support fixture;
a retaining device on the fixture;
a first alignment member supported on the fixture and positioned to cooperate with the first alignment surface of the object;
a second alignment member supported on the fixture and positioned to cooperate with the second alignment surface of the object;
a first pusher supported on the fixture and having a relaxed position and a tensioned position, the first pusher arranged to cooperate with the object to move the first alignment surface of the object firmly against the first alignment member as the first pusher is moved from the relaxed position to the tensioned position;
a second pusher supported on the fixture and having a relaxed position and a tensioned position, the second pusher arranged to cooperate with the object to move the second alignment surface of the plate firmly against the second alignment member as the second pusher is moved from the relaxed position to the tensioned position;
a controller operably connected to the retaining device, the first pusher, and the second pusher, and
wherein the controller directs the first pusher to its tensioned position, directs the second pusher to its tensioned position, and directs the clamp to be activated, so that the object is retained in the object holder in a desired orientation.

36. The object holder according to claim 35, wherein the object is a microtiter plate.

37. The object holder according to claim 36, wherein the retaining device is a vacuum plate connected to a vacuum source.

38. The object holder according to claim 37, wherein the object is a microtiter plate that has a well area, and the vacuum plate cooperates with a bottom of the well area to securely hold the plate.

39. A method of receiving and retaining an object in a desired orientation, the object having a first alignment surface and a second alignment surface, the method comprising:
placing the first alignment surface of the object loosely adjacent a first alignment member, and placing the second alignment surface of the object loosely adjacent a second alignment member;
moving a first pusher against the object so that the first alignment surface is held firmly against the first alignment member; and
moving a second pusher against the object so that the second alignment surface is held firmly against the second alignment member.

40. The method of claim 39, wherein the method further comprises verifying that either or both of the first pusher and the second pusher are properly positioned to hold the object against the alignment members.

41. The method of claim 39, wherein the method further comprises activating a retention device that holds the object in the desired orientation.

42. A software program which operates on a controller, wherein the software directs the controller to implement the method of claim 39.
